(19) United States
(12) Patent Application Publication
(10) Pub. No.: US 2017/0008163 A1
(43) Pub. Date: Jan. 12, 2017

(54) ROBOTIC BIN MANAGEMENT SYSTEM AND METHOD

(71) Applicant: Willow Garage Inc., Menlo Park, CA (US)

(72) Inventor: Steve Cousins, Menlo Park, CA (US)

(73) Assignee: Willow Garage Inc., Menlo Park, CA (US)

(21) Appl. No.: 15/272,334

(22) Filed: Sep. 21, 2016

Related U.S. Application Data
(63) Continuation of application No. 14/316,718, filed on Jun. 26, 2014, now abandoned.
(60) Provisional application No. 61/957,254, filed on Jun. 26, 2013.

(51) Int. Cl. B25J 9/00; B25J 9/16; B25J 11/00; B25J 5/00; G05D 1/02; B25J 19/02

(52) U.S. Cl. CPC B25J 9/0003; G05D 1/0231; B25J 19/023; B25J 11/008; B25J 5/007; B25J 9/1679; Y10S 901/01; G05D 2201/0216; G05B 2219/39107

(57) ABSTRACT

One embodiment is directed to a personal robotic system, comprising: an electromechanical mobile base defining a cross-sectional envelope when viewed in a plane substantially parallel to a plane of a floor upon which the mobile base is operated; a torso assembly movably coupled to the mobile base; a head assembly movably coupled to the torso; a releasable bin-capturing assembly movably coupled to the torso; and a controller operatively coupled to the mobile base, torso assembly, head assembly, and bin-capturing assembly, and configured to capture a bin with the bin-capturing assembly and move the torso assembly relative to the mobile base so that the captured bin fits as closely as possible within the cross-sectional envelope of the mobile base.

### RELATED APPLICATION DATA

The present application is a continuation application of U.S. patent application Ser. No. 14/316,718, filed on Jun. 26, 2014, which claims the benefit under 35 U.S.C. §119 to U.S. Provisional Application Ser. No. 61/957,254 filed Jun. 26, 2013. The foregoing application is hereby incorporated by reference into the present application in its entirety.

### FIELD OF THE INVENTION

The present invention relates generally to robotic systems for use in human environments, and more particularly to automated and semiautomated systems for assisting in the organization of human scale objects which may be contained in structures such as movable bins.

### BACKGROUND

Personal robots, such as those available under the tradenames Roomba® and PR2® by suppliers such as iRobot® and Willow Garage®, respectively, have been utilized in human environments to assist with human-scale tasks such as vacuuming and grasping various items, but neither of these personal robotic systems, nor others that are available, are well suited for operating in human environments such as elderly care facilities, hotels, or hospitals in a manner wherein they may be utilized to move objects around in a highly efficient manner via the incorporation and use of containers such as plastic or metal bins to isolate and carry groups of objects. In particular, there is a need for reliable and controllable systems that are capable of autonomous, semi-autonomous, and/or teleoperational activity in such environments wherein an objective is the movement of other human scale objects, such as almost any object or objects of reasonable mass and/or size that may be placed in a bin that may otherwise be manipulated and carried manually by a human. The embodiments described herein are intended to meet these and other objectives.

### BRIEF DESCRIPTION OF THE DRAWINGS

FIGS. 1A-1G illustrate conventional robotic systems that may be utilized in human environments for various tasks.

FIGS. 2A-2N illustrate various aspects of a personal robotic system in accordance with the present invention.

FIGS. 3A-3K illustrate various aspects of a personal robotic system in accordance with the present invention.

### SUMMARY OF THE INVENTION

One embodiment is directed to a personal robotic system, comprising: an electromechanical mobile base defining a cross-sectional envelope when viewed in a plane substantially parallel to a plane of a floor upon which the mobile base is operated; a torso assembly movably coupled to the mobile base; a head assembly movably coupled to the torso; a releasable bin-capturing assembly movably coupled to the torso; and a controller operatively coupled to the mobile base, torso assembly, head assembly, and bin-capturing assembly, and configured to capture a bin with the bin-capturing assembly and move the torso assembly relative to the mobile base so that the captured bin fits as closely as possible within the cross-sectional envelope of the mobile base. The system further may comprise a sensor operatively coupled to the controller and configured to sense one or more factors regarding an environment in which the mobile base is navigated. The sensor may comprise a sonar sensor. The sonar sensor may be coupled to the mobile base. The sensor may comprise a laser range finder. The laser rangefinder may be configured to scan a forward field of view that is greater than about 90 degrees. The laser rangefinder may be configured to scan a forward field of view that is about 180 degrees. The sonar sensor may be coupled to the mobile base. The sensor may comprise an image capture device. The image capture device may comprise a 3-D camera. The image capture device may be coupled to the head assembly. The image capture device may be coupled to the mobile base. The image capture device may be coupled to the releasable bin-capturing assembly. The image capture device may be coupled to the torso assembly. The mobile base may comprise a differential drive configuration having two driven wheels. Each of the driven wheels may be operatively coupled to an encoder that is operatively coupled to the controller and configured to provide the controller with input information regarding a driven wheel position. The controller may be configured to operate the driven wheels to navigate the mobile base based at least in part upon the input information from the driven wheel encoders. The controller may be configured to operate the mobile base based at least in part upon signals from the sensor. The torso assembly may be movably coupled to the mobile base such that the torso may be controllably elevated and lowered along an axis substantially perpendicular to the plane of the floor. The torso assembly may be movably coupled to the mobile base such that the torso may be controllably moved along an axis substantially parallel to the plane of the floor. The head assembly may comprise an image capture device. The image capture device may comprise a 3-D camera. The image capture device may be movably coupled to the head assembly such that it may be controllably panned or tilted relative to the head assembly. The bin-capturing assembly may comprise an under-ledge capturing surface configured to be interfaced with a ledge geometry feature of the bin. The capturing surface may comprise a rail. The rail and ledge geometry feature of the bin may be substantially straight. The system further may comprise a wireless transceiver configured to enable a teleoperating operator to remotely connect with the controller from a remote workstation, and to operate at least the mobile base. The controller may be configured to navigate, observe the environment, and engage with one or more bins based at least in part upon teleoperation signals through the wireless transceiver from the teleoperating operator. The controller may be configured to use the image capture device to automatically recognize the bin. One or more tags may be coupled to the bin, the tags being configured to be recognizable and readable by the controller using the image capture device. At least one of the one of more tags may be configured to assist the controller in determining the identification of the bin. At least one of the one or more tags may be configured to assist the controller in determining the geometric pose of the bin. The one or more tags may be selected from the group consisting of a QR code, an AR tag, a 2-D barcode, and a 3-D barcode. The one or more tags may be passive. The one or more tags may be actively-powered. The controller may be configured to use the image capture device to automatically recognize one or more tags associated with a location in the nearby environment. At least one of the one of more tags may be configured to assist the controller in determining the identification of the location. At least one of the one or more tags may be configured to assist the controller in determining the geometric pose of the location. The one or more tags may be selected from the group consisting of a QR code, an AR tag, a 2-D barcode, and a 3-D barcode. The one or more tags may be passive. The one or more tags may be actively-powered. The controller may be configured to use the image capture device to automatically recognize one or more tags associated with an object in the nearby environment. At least one of the one of more tags may be configured to assist the controller in determining the identification of the object. At least one of the one or more tags may be configured to assist the controller in determining the geometric pose of the object. The one or more tags may be selected from the group consisting of a QR code, an AR tag, a 2-D barcode, and a 3-D barcode. The one or more tags may be passive. The one or more tags may be actively-powered.

Another embodiment is directed to a method for managing bins of physical objects in a human environment, comprising: providing a personal robotic system comprising an electromechanical mobile base defining a cross-sectional envelope when viewed in a plane substantially parallel to a plane of a floor upon which the mobile base is operated; a torso assembly movably coupled to the mobile base; a head assembly movably coupled to the torso; a releasable bin-capturing assembly movably coupled to the torso; and a controller operatively coupled to the mobile base, torso assembly, head assembly, and bin-capturing assembly; and operating the personal robotic system to capture a bin with the bin-capturing assembly and move the torso assembly relative to the mobile base so that the captured bin fits as closely as possible within the cross-sectional envelope of the mobile base. The method further may comprise providing a sensor operatively coupled to the controller and configured to sense one or more factors regarding an environment in which the mobile base is navigated. The sensor may comprise a sonar sensor. The sonar sensor may be coupled to the mobile base. The sensor may comprise a laser range finder. The laser rangefinder may be configured to scan a forward field of view that is greater than about 90 degrees. The laser rangefinder may be configured to scan a forward field of view that is about 180 degrees. The sonar sensor may be coupled to the mobile base. The sensor may comprise an image capture device. The image capture device may comprise a 3-D camera. The image capture device may be coupled to the head assembly. The image capture device may be coupled to the mobile base. The image capture device may be coupled to the releasable bin-capturing assembly. The image capture device may be coupled to the torso assembly. The mobile base may comprise a differential drive configuration having two driven wheels. Each of the driven wheels may be operatively coupled to an encoder that is operatively coupled to the controller and configured to provide the controller with input information regarding a driven wheel position. The controller may be configured to operate the driven wheels to navigate the mobile base based at least in part upon the input information from the driven wheel encoders. The controller may be configured to operate the mobile base based at least in part upon signals from the sensor. The torso assembly may be movably coupled to the mobile base such that the torso may be controllably elevated and lowered along an axis substantially perpendicular to the plane of the floor. The torso assembly may be movably coupled to the mobile base such that the torso may be controllably moved along an axis substantially parallel to the plane of the floor. The head assembly may comprise an image capture device. The image capture device may comprise a 3-D camera. The image capture device may be movably coupled to the head assembly such that it may be controllably panned or tilted relative to the head assembly. The bin-capturing assembly may comprise an under-ledge capturing surface configured to be interfaced with a ledge geometry feature of the bin. The capturing surface may comprise a rail. The rail and ledge geometry feature of the bin may be substantially straight. The method further may comprise providing a wireless transceiver configured to enable a teleoperating operator to remotely connect with the controller from a remote workstation, and to operate at least the mobile base. The controller may be configured to navigate, observe the environment, and engage with one or more bins based at least in part upon teleoperation signals through the wireless transceiver from the teleoperating operator. The controller may be configured to use the image capture device to automatically recognize the bin. One or more tags may be coupled to the bin, the tags being configured to be recognizable and readable by the controller using the image capture device. At least one of the one of more tags may be configured to assist the controller in determining the identification of the bin. At least one of the one or more tags may be configured to assist the controller in determining the geometric pose of the bin. The one or more tags may be selected from the group consisting of a QR code, an AR tag, a 2-D barcode, and a 3-D barcode. The one or more tags may be passive. The one or more tags may be actively-powered. The controller may be configured to use the image capture device to automatically recognize one or more tags associated with a location in the nearby environment. At least one of the one of more tags may be configured to assist the controller in determining the identification of the location. At least one of the one or more tags may be configured to assist the controller in determining the geometric pose of the location. The one or more tags may be selected from the group consisting of a QR code, an AR tag, a 2-D barcode, and a 3-D barcode. The one or more tags may be passive. The one or more tags may be actively-powered. The controller may be configured to use the image capture device to automatically recognize one or more tags associated with an object in the nearby environment. At least one of the one of more tags may be configured to assist the controller in determining the identification of the object. At least one of the one or more tags may be configured to assist the controller in determining the geometric pose of the object. The one or more tags may be selected from the group consisting of a QR code, an AR tag, a 2-D barcode, and a 3-D barcode. The one or more tags may be passive. The one or more tags may be actively-powered.

### DETAILED DESCRIPTION

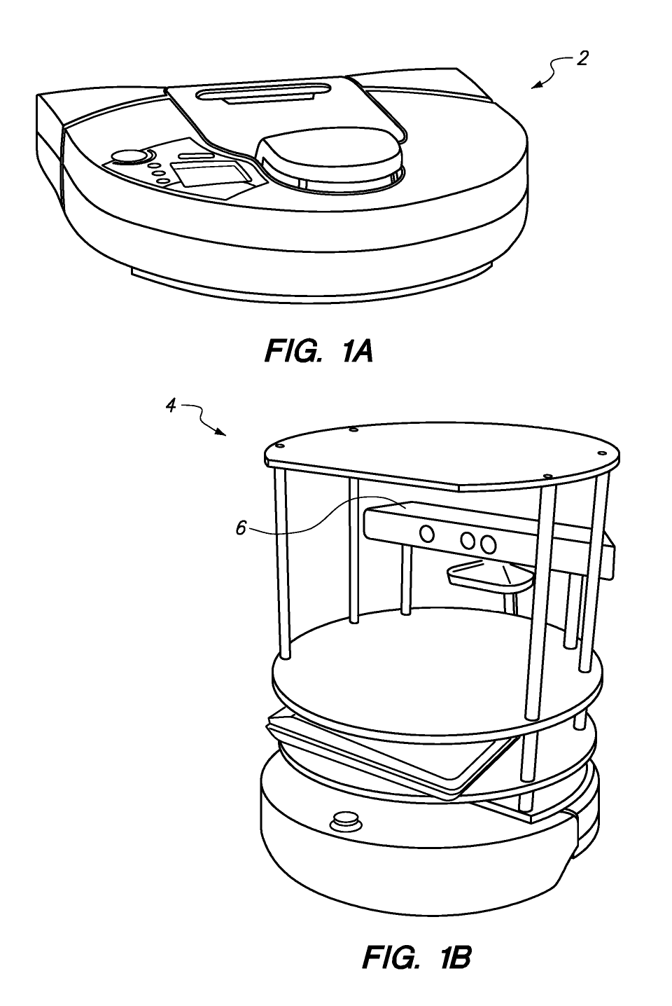

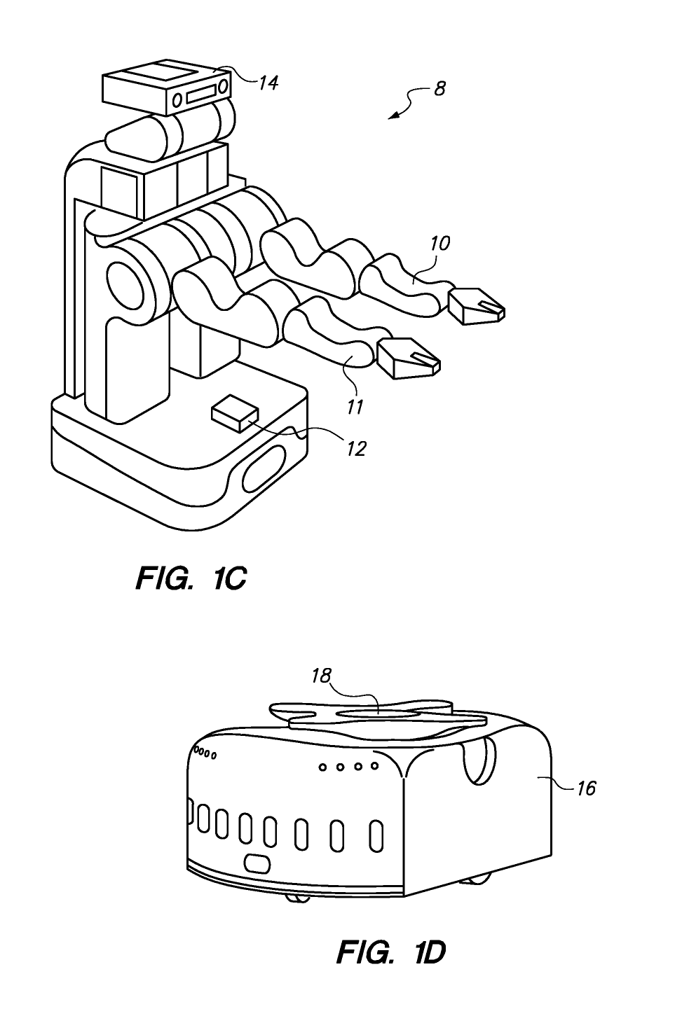

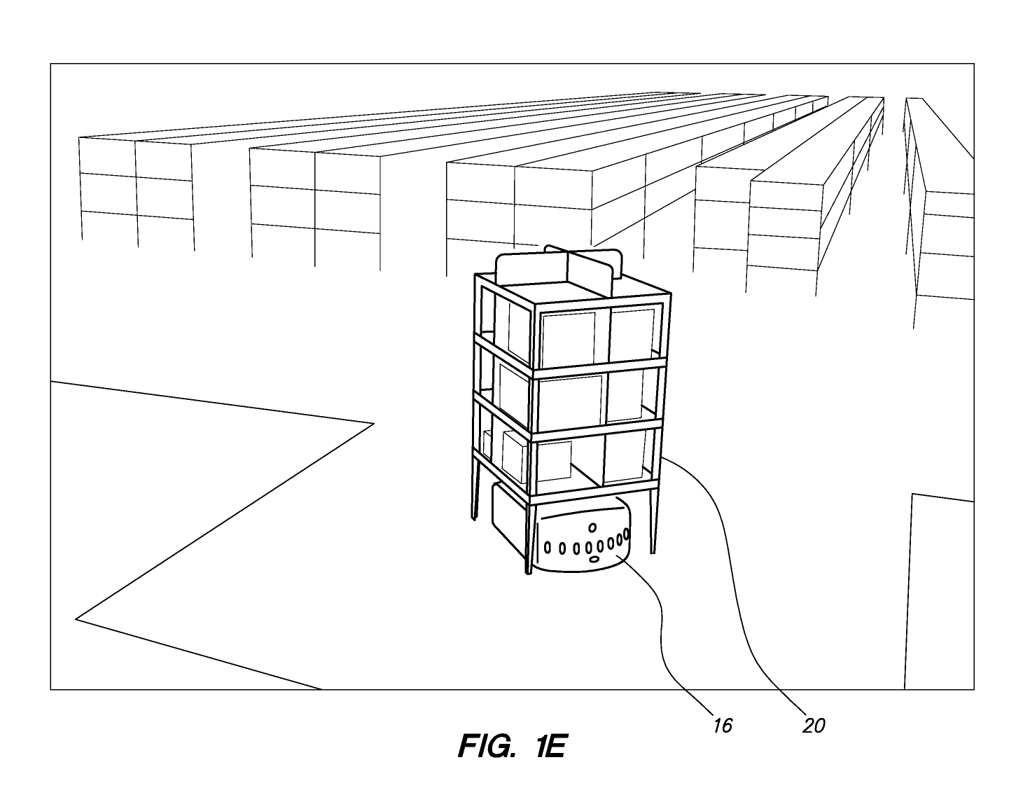

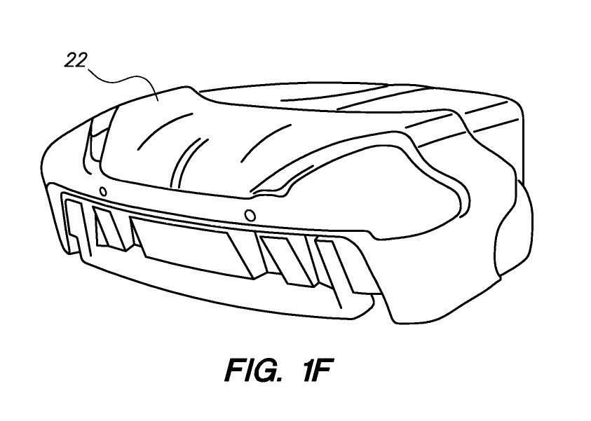

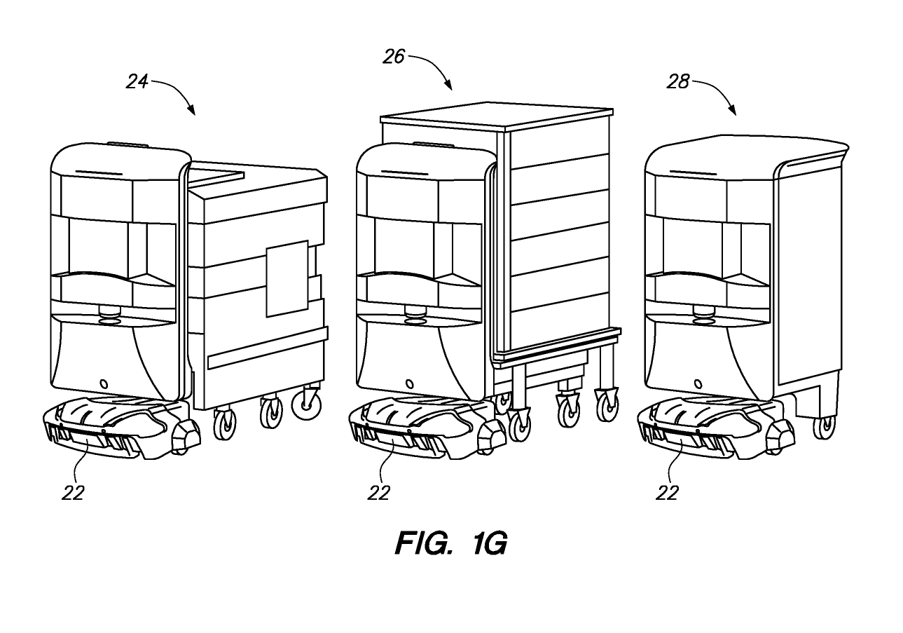

Referring to FIG. 1A, a vacuuming robot (2) is depicted which has primary function for vacuuming floors in a human environment, and has little other utility due to its design. FIG. 1B illustrates a lightweight robotics platform (4) sold under the tradename “Turtlebot”® by Willow Garage, Inc., which features a 3-D camera, such as those available under the tradename Kinect® from Microsoft Corp. Such a platform may be programmed to handle light duty tasks, such as moving around a plate or two, or some lightweight tools or food. FIG. 1C illustrates a heavier duty personal robotics platform (8) sold under the tradename “PR2” by Willow Garage, Inc. This platform features two sophisticated arms (10, 11), a multi-sensor head (14), and a laser scanner (12) coupled to the mobile base component and is capable of conducting certain human-scale tasks, but is not optimized for handling inventory or bin management exercises. FIG. 1D features a small robotic system (16) sold by Kiva, Inc., which is designed to be utilized in inventorying and warehousing scenarios by virtue of a centrally-located loading interface (18), which may be utilized to lift and move large racks (20), as shown in the illustration of FIG. 1E. FIG. 1F features a tug-style robotic system (22) sold under the tradename “Tug”® by Aethon, Inc., which may be utilized to pull various types of loads, as shown in the three embodiments (24, 26, 28) depicted in FIG. 1G. As noted above, none of these robotic systems is optimized for handling and managing bins of objects at the human scale which may be shelved, stored, and moved to various locations within a human environment to save manual labor trips for completing such tasks.

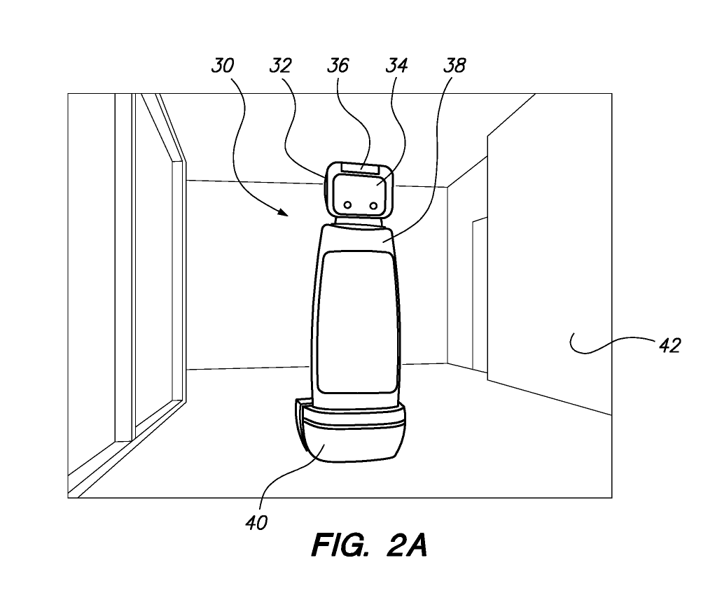

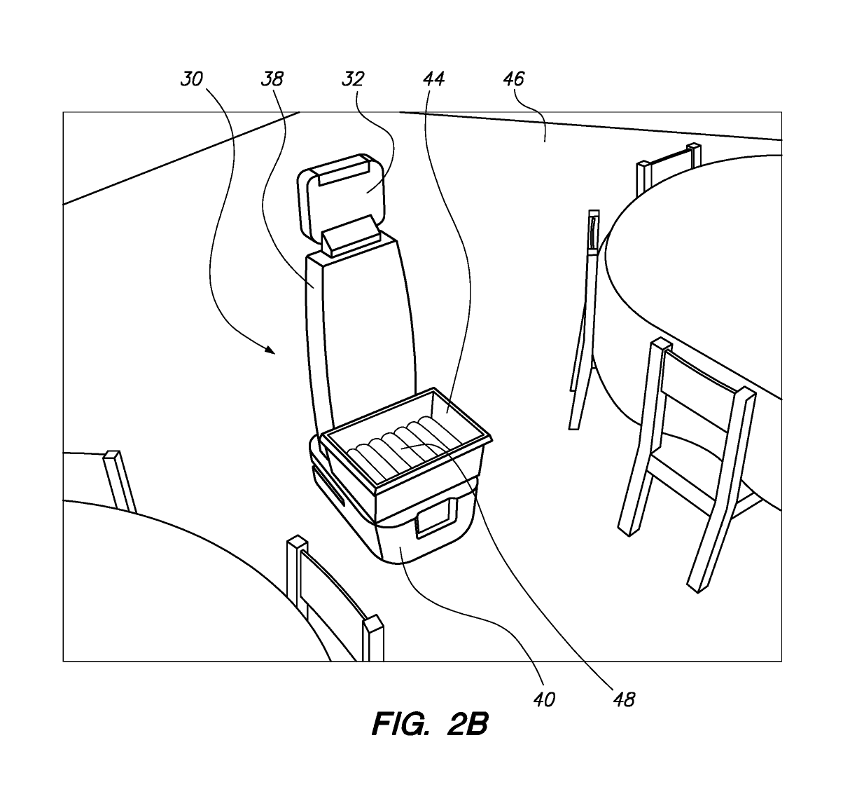

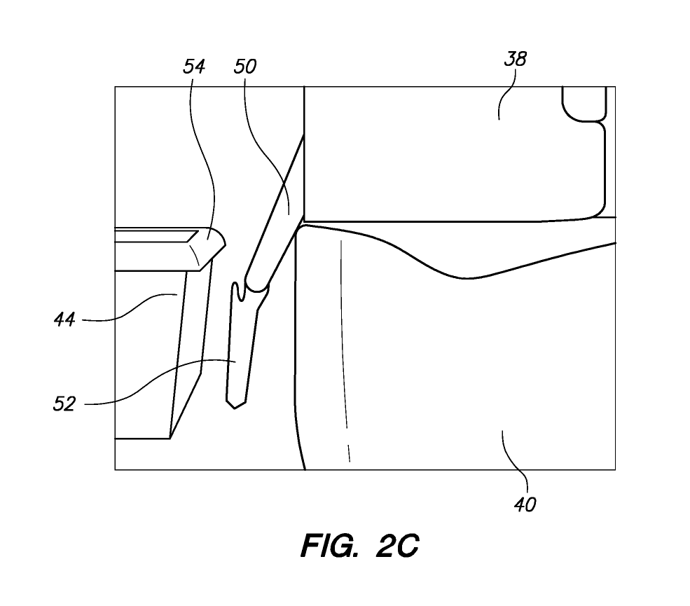

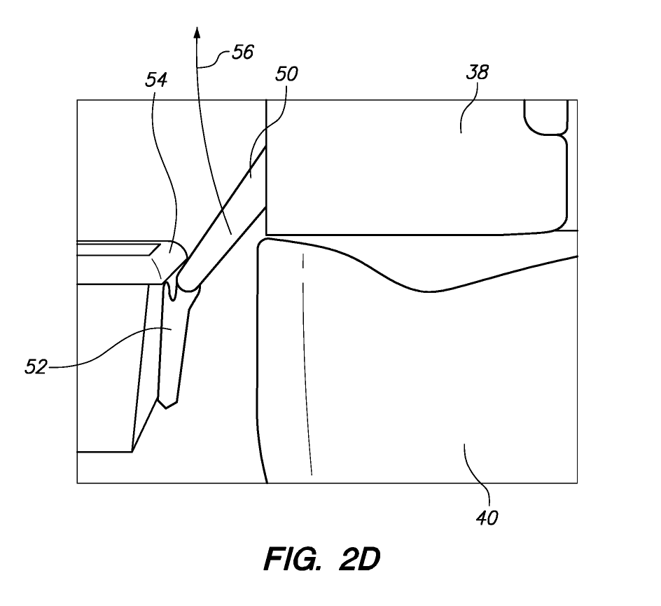

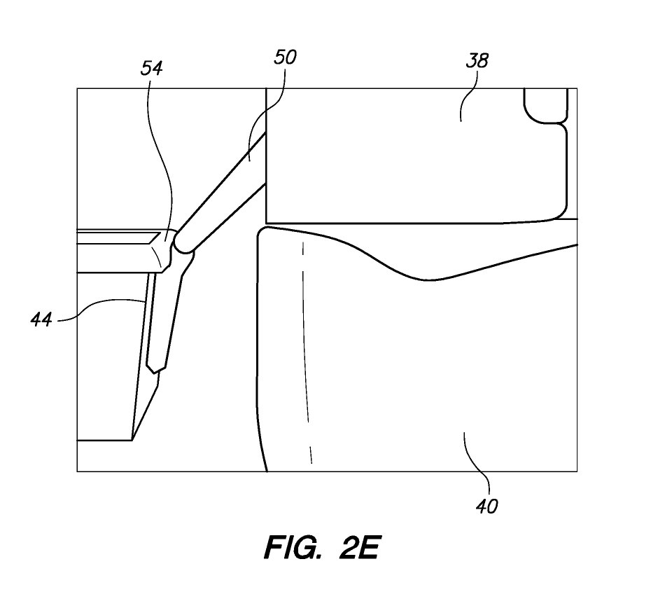

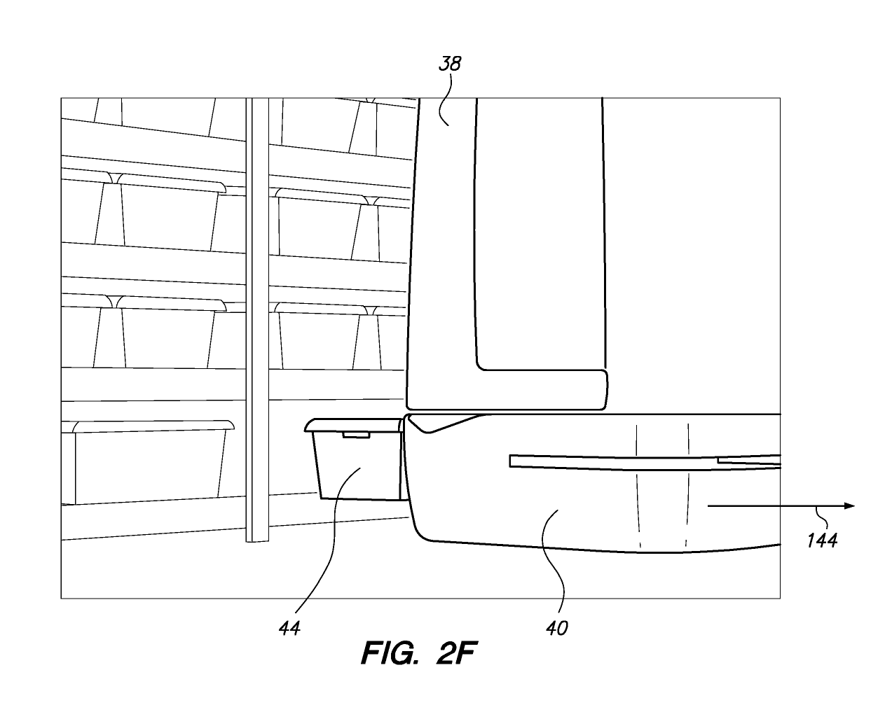

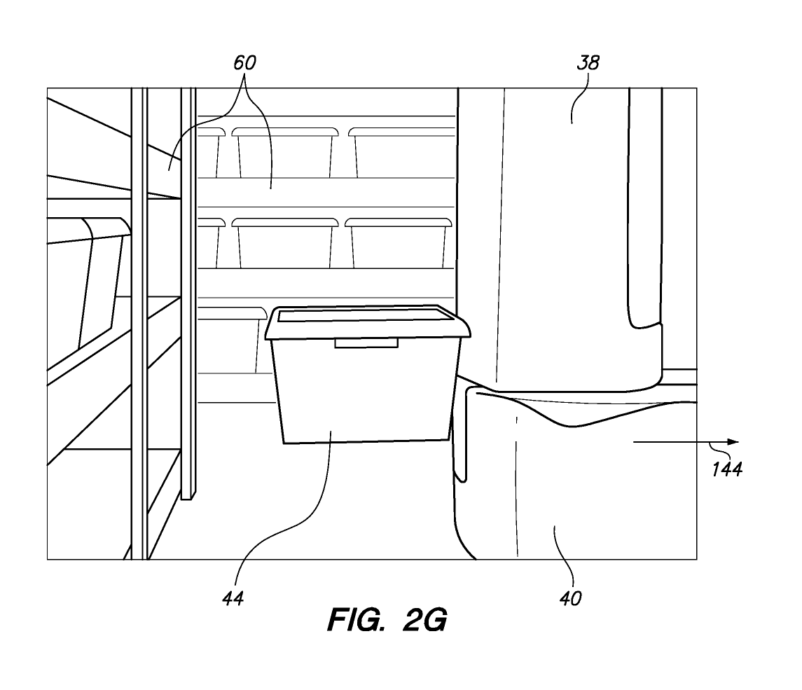

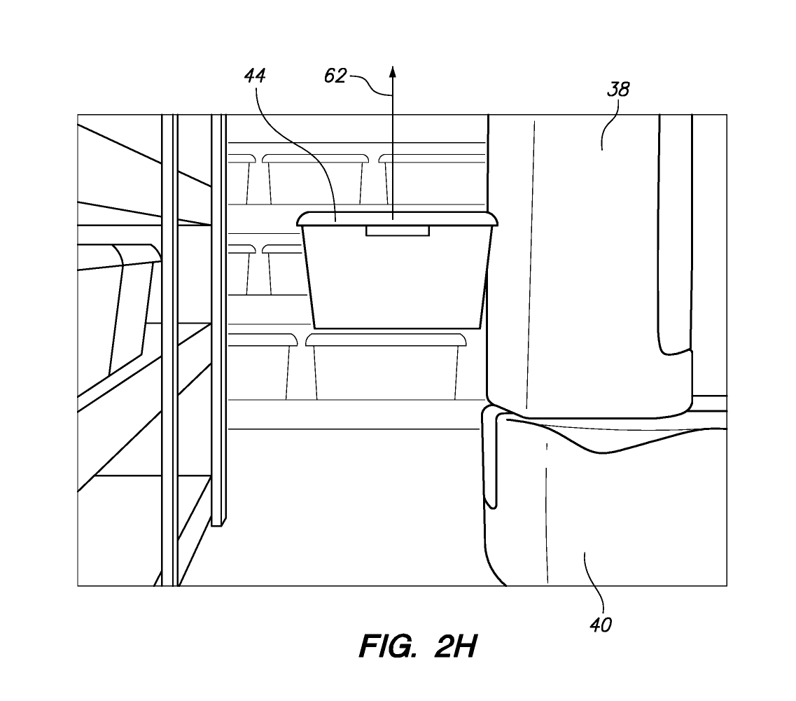

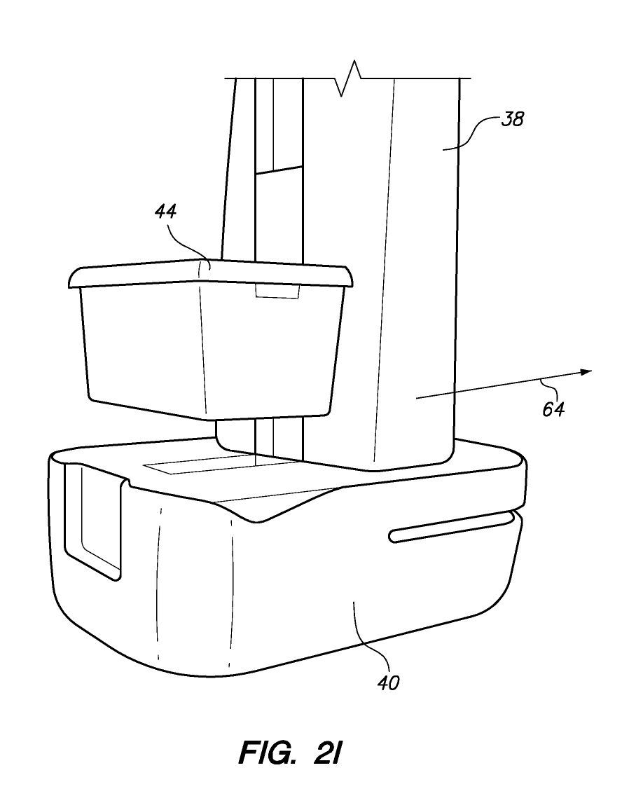

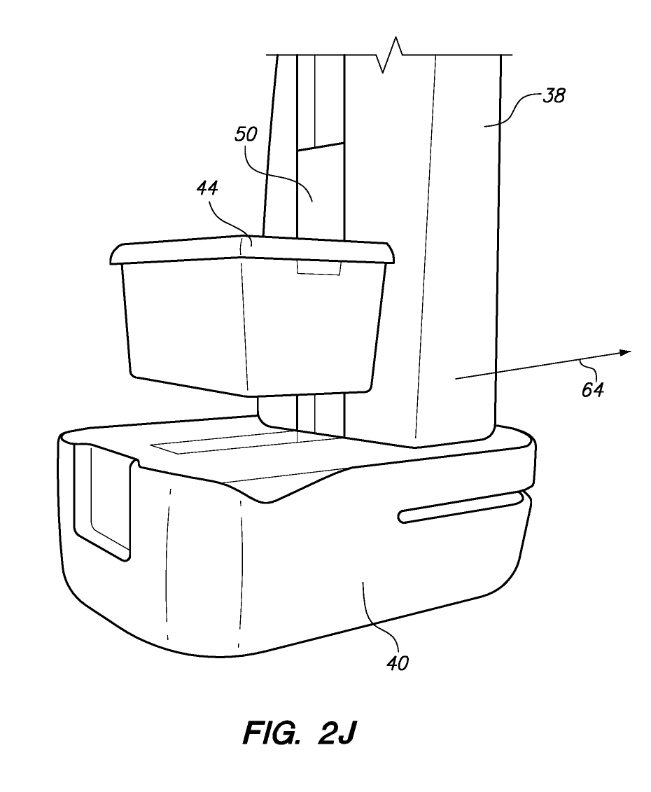

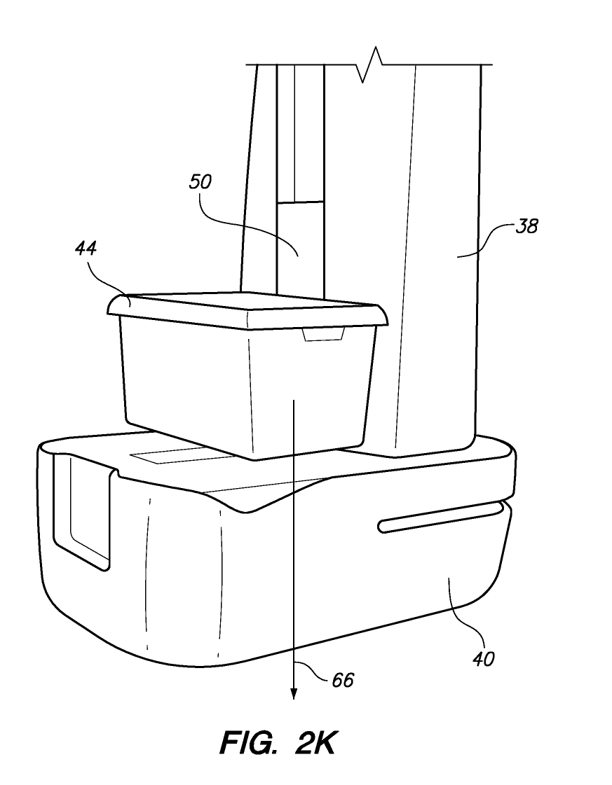

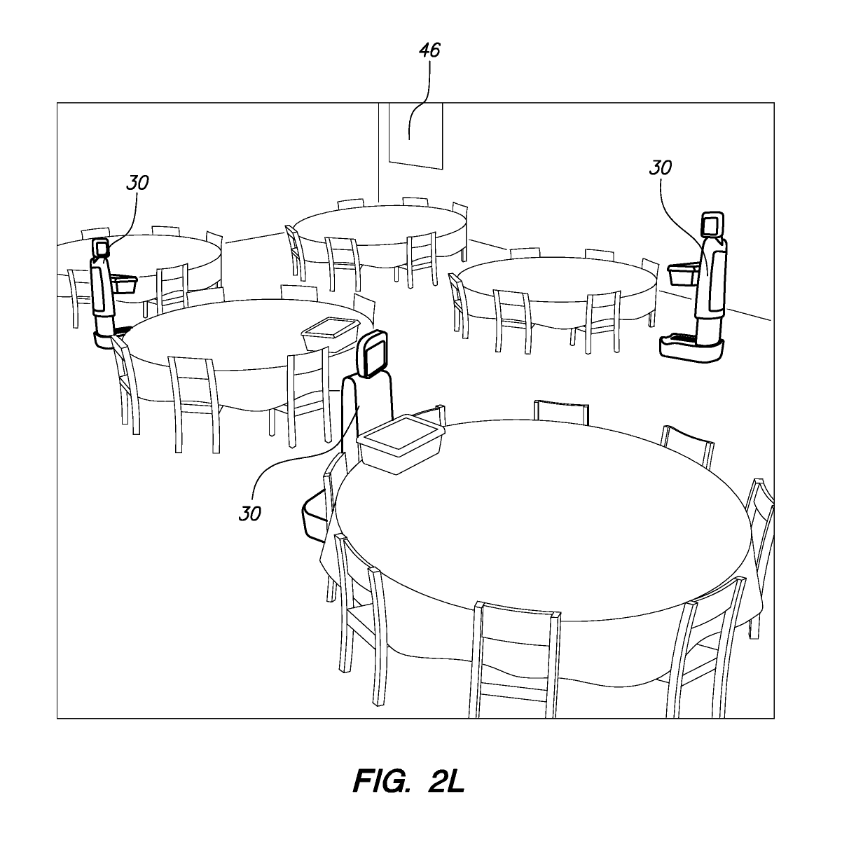

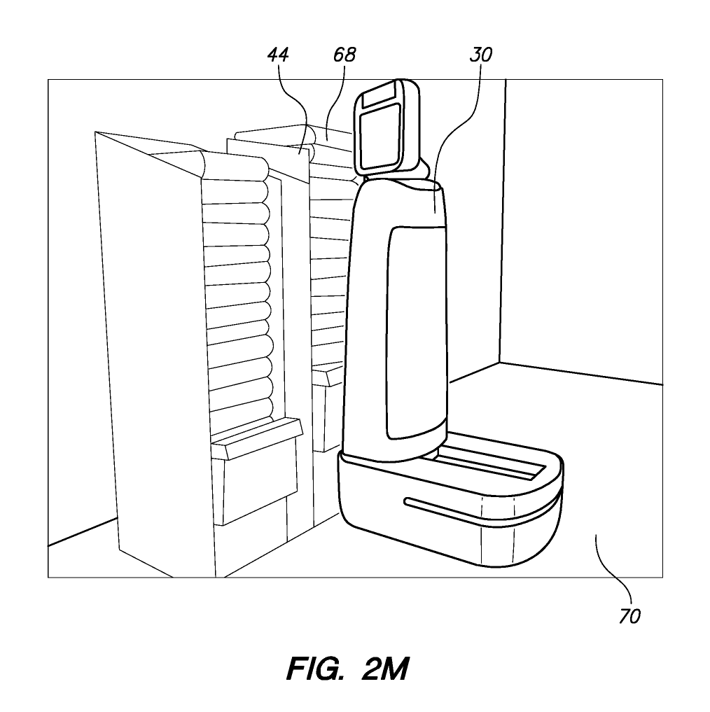

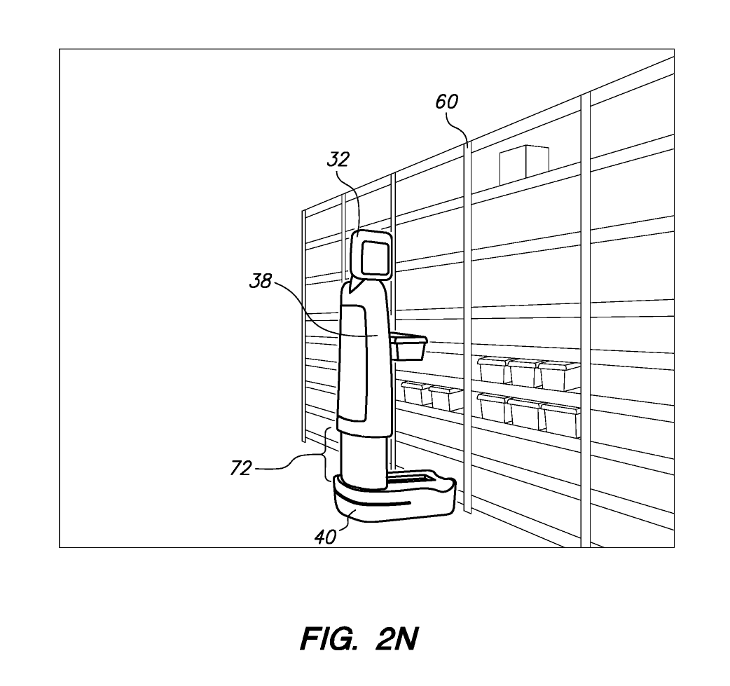

Referring to FIGS. 2A-2N, various scenarios are illustrated wherein the subject bin management robotic system may be utilized in various human embodiments to assist humans in daily tasks. FIG. 2A shows a robotic system (30) moving through a hallway environment (42) using an electromechanically mobile base (40) coupled to a torso assembly (38), which is coupled to a head assembly (32) and releasable bin capturing assembly (not shown in FIG. 2A; shown as element 50 in FIG. 2B, for example). The head assembly (32) may comprise a display (34) which may be utilized to communicate status, mission, task, or even personality information (i.e., such as a smile for a system that is functioning property without any errors—or simulated eyes to provide an indication regarding where the robot may be examining sensor information or moving forward). The head assembly (32) may also comprise one or more image capture devices, such as an infrared camera, a conventional camera, or a 3-D camera (36) such as those available from Microsoft Corp. under the tradename Kinect®, which may be movably coupled to the rest of the head assembly to provide pan, tilt, rotate, or other degrees of freedom of motion between the camera and the rest of the head assembly, which may assist with image capture, control, and/or visualization.

Referring to FIG. 2B, a robotic system (30) is depicted in a dining room environment (46) wherein it is carrying a bin (40) full of napkins (48) or other objects useful and/or desired in the environment. Preferably the overall cross sectional envelope or footprint in a plane substantially parallel to the floor of the environment is relatively small, such as the approximate cross sectional envelope of a typical person. In the depicted embodiment, it is noteworthy that the bin is coupled to the robotic system (30) in a manner wherein the bin only contributes a minimal amount to the cross sectional envelope of the robotic system and its payload—this is valued because it is preferable to keep this envelope minimal in the human environment wherein space can be at a premium, and wherein it is desirable for the robotic system (30) to operate as minimally invasively in such environment as possible.

Referring to FIG. 2C, a robotic system is shown adjacent a stored bin (44) which is to be picked up. The robotic system may be configured to extend out a portion of the bin capturing assembly (50) as shown, to engage the targeted bin (44). The bin (44) may comprise a ledge geometric feature (54) that may be mated with a rail-type geometric feature (52) of the bin capturing assembly (50), as is shown in FIGS. 2D and 2E while the bin capturing assembly (50) is raised upward (56) away from the floor to lift and capture the bin (44), after which it may be pulled away (144) from the shelf by moving the mobile base (40) away, as shown in FIG. 2F. FIGS. 2G-2H show the system elevating (62) the captured bin (44) so that it may be moved closer toward the center of mass of the entire robotic/payload assembly, as shown in FIGS. 2I-2J, wherein the torso assembly (38) is being moved (64) along relative to the mobile base (40) in a direction substantially parallel to the floor of the environment, before the bin capturing assembly is moved back downward (66) relative to the mobile base assembly (40), as shown in FIG. 2K, so that the bin may be rested on top of the mobile base during transport to a destination in the human environment. FIG. 2L illustrates that it may be helpful to have multiple such robotic systems (30) assisting in the same environment (46). FIG. 2M illustrates that many environments may be assisted by this type of bin management configuration, such as a workout room environment (70), wherein a robotic system (30) may be utilized to carry in a bin (44) of fresh towels (68). Referring to FIG. 2N, in one embodiment, the torso assembly (38) may be movably coupled to the movable base with not only the horizontal movement degree of freedom as described above, but also with an elevation/return (72) degree of freedom to facilitate in reaching higher bins and higher storage areas, such as the relatively high bin shelving configuration (60) depicted in FIG. 2N.

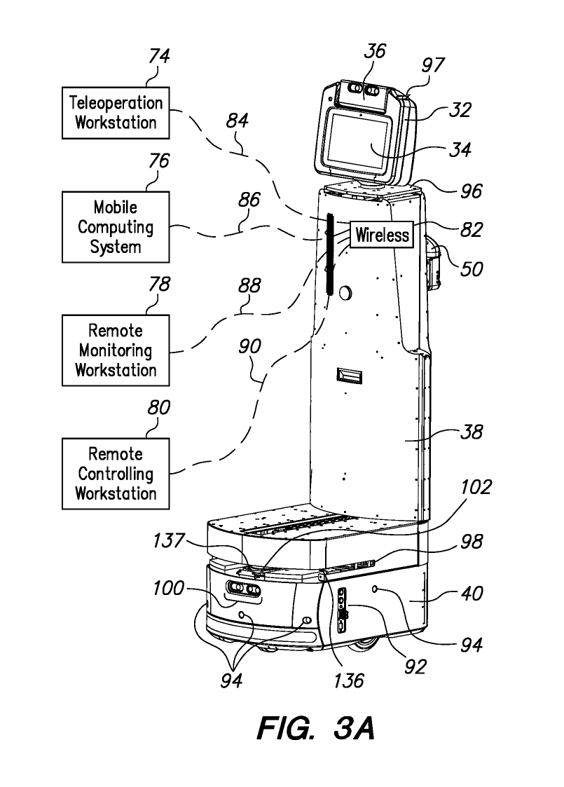

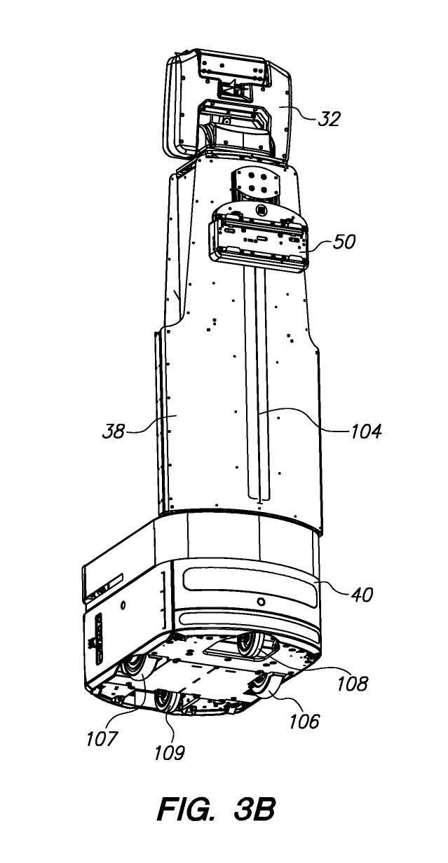

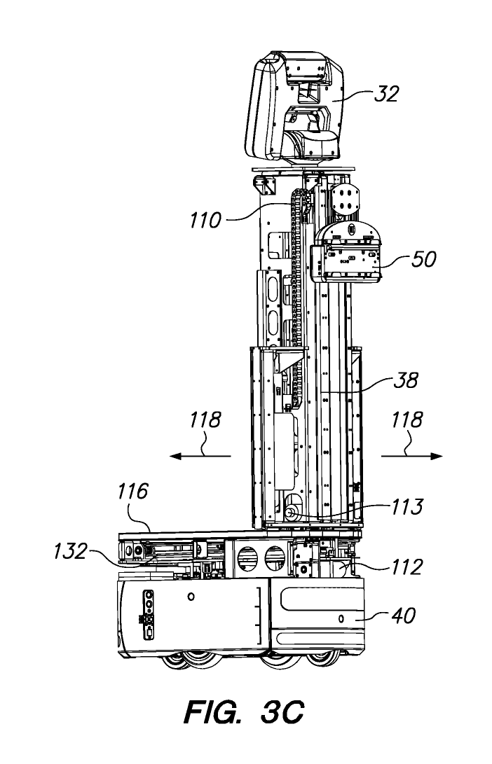

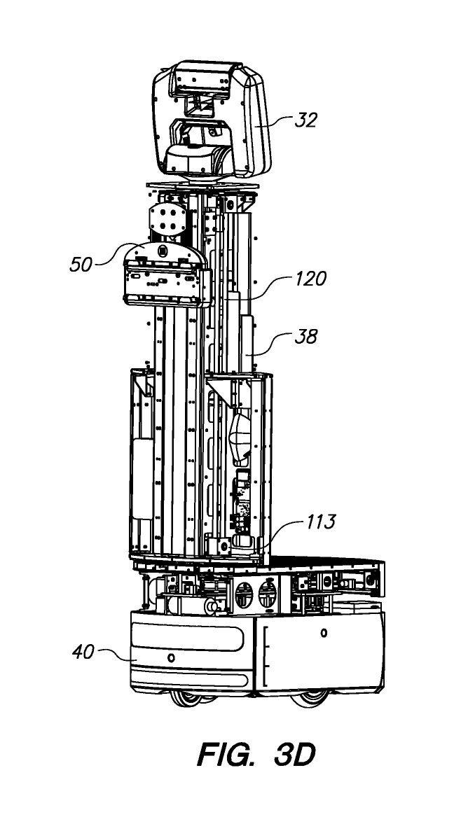

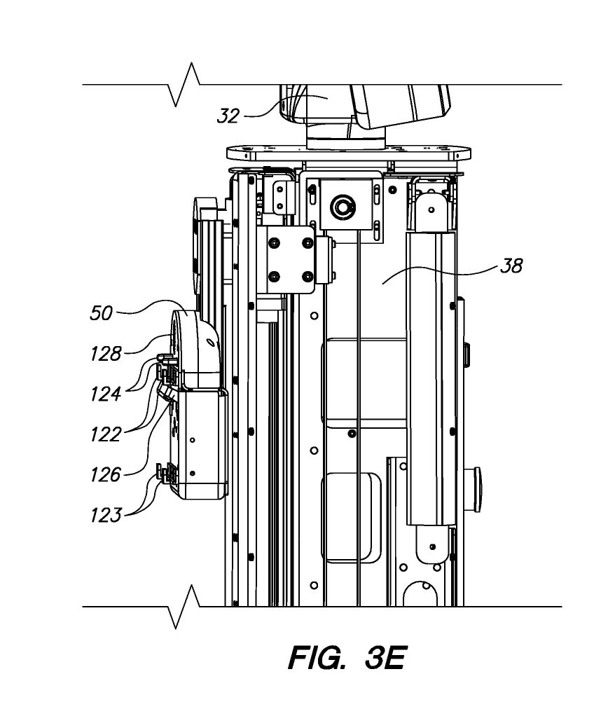

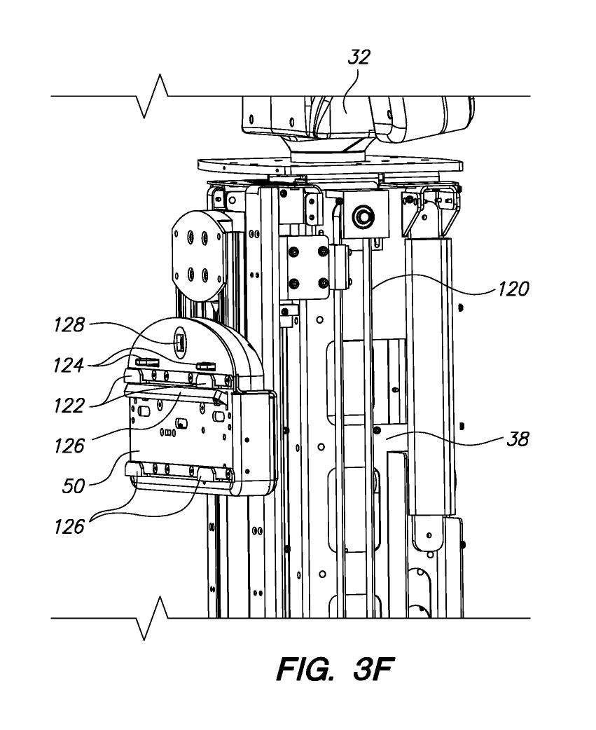

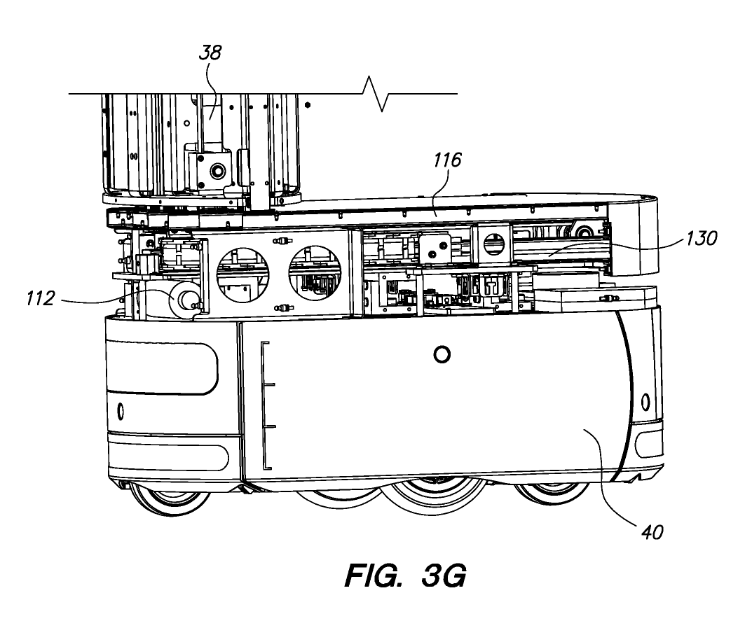

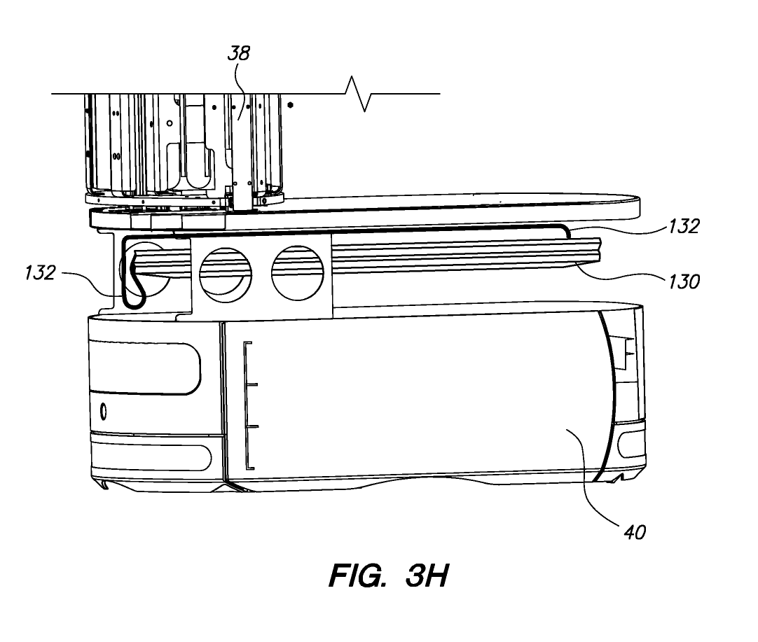

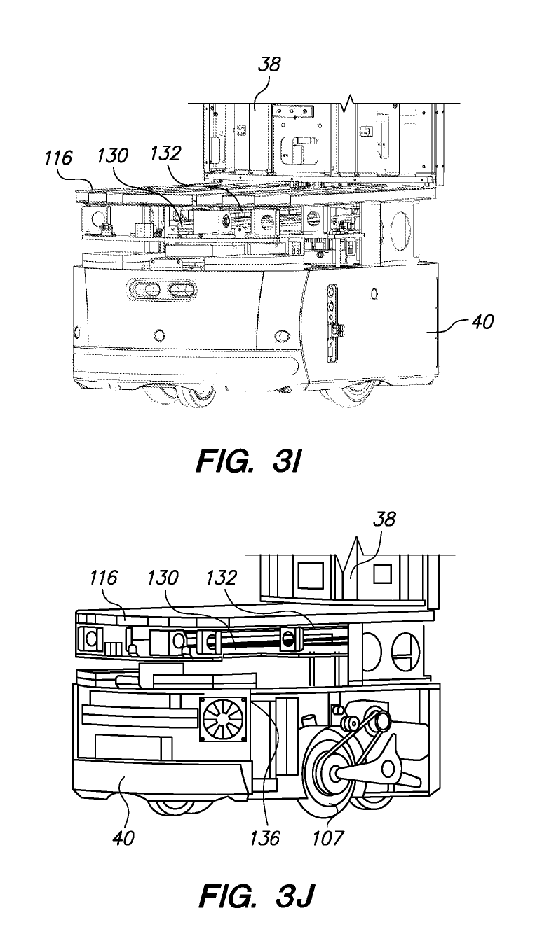

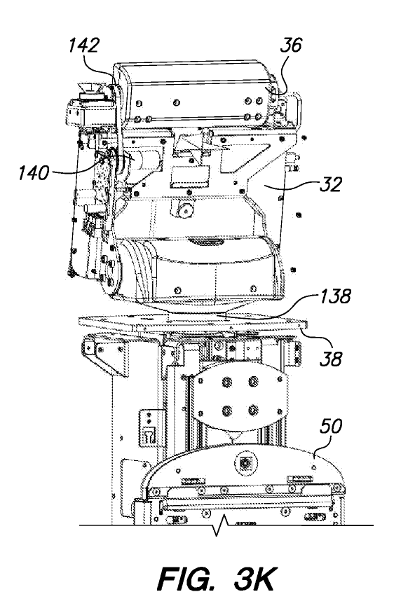

Referring to FIGS. 3A-3K, additional aspects of a suitable robotic system design are illustrated. Referring to FIG. 3A, a controller (136), located within the mobile base (or in other embodiments in the torso 38 or head 32 assemblies) may be operatively coupled to a mobile power supply (137), such as an internally-located battery. The controller (137) preferably is configured to receive signals and information from a variety of sensors, from pre-programmed logic operating devices, and from humans or other systems which may be in the loop or operatively coupled thereto. For example, in the embodiment of FIG. 3A, using a wireless transceiver (82) such as a WiFi router or access point, a cellular mobile transceiver (i.e., such as a 4G-LTE mobile device), or other wireless communication technology (i.e., such as Bluetooth or other RF technologies), the system controller may be operatively coupled (84, 86, 88, 90, respectively) with a teleoperation workstation (74), such as a remotely-located laptop computer, a mobile computing system (76), such as a mobile smartphone, a remote monitoring workstation (78), such as a computerized monitoring console, and/or a remote controlling workstation (80), such as a remotely-located computing workstation that may be configured to coordinate the activities of one or more such robotic systems in a given human environment. Each of these coupled devices may be utilized to operate and/or control the robot through the controller (136), which may be a computer processor such as those marketed by Intel Corporation under the tradename “i-Series”® processors. The system may comprise encoders operatively coupled to each moving joint (i.e., such as the wheel axles, any degrees of freedom between the components, elevation and/or rotation features, etc), image capture devices with fields of view oriented in various directions or all directions around the robotic system (the embodiment of FIG. 3A, for example, features one image capture device having a ceiling/upward field of view from the torso 96; a similarly oriented image capture device having a ceiling/upward field of view from the head assembly (97), a forward-oriented sensor array (100) which may comprise various image capture devices such as infrared cameras, conventional light cameras, 3-D cameras, and the like. The depicted embodiment also features a laser scanner (102) having a forward-oriented field of scanning or field of view that is at least 90 degrees forward, and which may be approximately 180 degrees, 270 degrees, or greater, such range of scanning facilitated by a recess (98) formed into the exterior housing of the mobile base. The depicted mobile base features sonar sensors (94) distributed around the perimeter of the mobile base to assist with proximity sensing.

Referring to FIG. 3B, a differential drive configuration comprises two electromechanically driven wheels (107, 108) and two passive caster style wheels (109, 108) to assist with balancing. The bin capturing assembly (50) is configured to be movable up and down relative to the torso (38) assembly through a slot (104) formed through the housing of the torso.

Referring to FIG. 3C, with some of the housing elements removed, an e-chain connectivity conduit (110) to couple the bin capturing assembly (50) to the controller is shown, along with the electronic motor (113) that is configured to drive a belt to controllably elevate and lower the bin capturing assembly (50) relative to the torso assembly (38). Also shown is a motor (112) configured to move an intercoupled belt (132) to move (118) the entire torso assembly (38) in a direction substantially parallel to the plane of the associated floor, as described above, to enable a bin to be brought onto the mobile base (40) and rest upon the main support deck structure (116).

FIG. 3D illustrates the belt (120) and motor (113) configuration for elevating and lowering the bin capturing assembly (50) relative to the torso assembly (38). FIGS. 3E and 3F illustrate details of the bin capturing assembly (50), with an embodiment wherein a two groups of rail elements (123, 122) are configured to engage opposing ledge geometries upon a targeted bin. A series of controllably-movable latch members (126, 124) may be utilized to lock a captured bin ledge into place, thereby locking the bin against the robotic system. A small image capture device (128) such as a camera may be utilized to view a nearby targeted bin, or other structures or tags associated thereto.

FIG. 3G illustrates the rail structure (130) that facilitates movement of the torso (38) along the mobile base (40); the associated motor (112) is also depicted, and in FIGS. 3H and 3I, the associated drive belt (132) route is depicted. FIG. 3J illustrates that the driven wheels (element 107, for example) may be driven by small belts, transmissions, and other conventional driven wheel suspension and torque delivery elements. FIG. 3K illustrates that the movable image capture device (36) of the head assembly (32) may be electromechanically tilted using a motor (140) and associated belt (142). The neck joint (138) may be powered to provide a neck roll degree of freedom relative to the torso assembly (38).

Referring back to FIGS. 2A-2N, the robotic system may use various markers or tags, such as QR codes, AR tags, 2-D barcodes, 3-D barcodes, which may be either active or passively electrified to assist in communication, to gather information regarding the identification, geometric pose, location, content, or other parameter of any object in the environment that has such a tag or marker. For example, each bin may have a unique marker; each position upon a shelf may have a unique marker; locations within the human environment (i.e., as simple as a square position upon a piece of carpeting) may have a unique marker representative of the location, pose, or other parameters. Such elements may be utilized, in concert with inputs from pre-programmed computer software operated by the robotic controller, and inputs from various sensors, and inputs from humans who may be “in the loop”, such as via teleoperation, to efficiently accomplish tasks with such a system.

Various exemplary embodiments of the invention are described herein. Reference is made to these examples in a non-limiting sense. They are provided to illustrate more broadly applicable aspects of the invention. Various changes may be made to the invention described and equivalents may be substituted without departing from the true spirit and scope of the invention. In addition, many modifications may be made to adapt a particular situation, material, composition of matter, process, process act(s) or step(s) to the objective(s), spirit or scope of the present invention. Further, as will be appreciated by those with skill in the art that each of the individual variations described and illustrated herein has discrete components and features which may be readily separated from or combined with the features of any of the other several embodiments without departing from the scope or spirit of the present inventions. All such modifications are intended to be within the scope of claims associated with this disclosure.

Any of the devices described for carrying out the subject diagnostic or interventional procedures may be provided in packaged combination for use in executing such interventions. These supply “kits” may further include instructions for use and be packaged in trays or containers as commonly employed for such purposes.

The invention includes methods that may be performed using the subject devices. The methods may comprise the act of providing such a suitable device. Such provision may be performed by the end user. In other words, the “providing” act merely requires the end user obtain, access, approach, position, set-up, activate, power-up or otherwise act to provide the requisite device in the subject method. Methods recited herein may be carried out in any order of the recited events which is logically possible, as well as in the recited order of events.

Exemplary aspects of the invention, together with details regarding material selection and manufacture have been set forth above. As for other details of the present invention, these may be appreciated in connection with the above-referenced patents and publications as well as generally known or appreciated by those with skill in the art. The same may hold true with respect to method-based aspects of the invention in terms of additional acts as commonly or logically employed.

In addition, though the invention has been described in reference to several examples optionally incorporating various features, the invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention. In addition, where a range of values is provided, it is understood that every intervening value, between the upper and lower limit of that range and any other stated or intervening value in that stated range, is encompassed within the invention.

Also, it is contemplated that any optional feature of the inventive variations described may be set forth and claimed independently, or in combination with any one or more of the features described herein. Reference to a singular item, includes the possibility that there are plural of the same items present. More specifically, as used herein and in claims associated hereto, the singular forms “a,” “an,” “said,” and the include plural referents unless the specifically stated otherwise. In other words, use of the articles allow for at least one of the subject item in the description above as well as claims associated with this disclosure. It is further noted that such claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in claims associated with this disclosure shall allow for the inclusion of any additional element—irrespective of whether a given number of elements are enumerated in such claims, or the addition of a feature could be regarded as transforming the nature of an element set forth in such claims. Except as specifically defined herein, all technical and scientific terms used herein are to be given as broad a commonly understood meaning as possible while maintaining claim validity.

The breadth of the present invention is not to be limited to the examples provided and/or the subject specification, but rather only by the scope of claim language associated with this disclosure.

1. A personal robotic system, comprising:
a. an electromechanical mobile base defining a cross-sectional envelope when viewed in a plane substantially parallel to a plane of a floor upon which the mobile base is operated;
b. a torso assembly movably coupled to the mobile base;
c. a head assembly movably coupled to the torso;
d. a releasable bin-capturing assembly movably coupled to the torso; and
e. a controller operatively coupled to the mobile base, torso assembly, head assembly, and bin-capturing assembly, and configured to capture a bin with the bin-capturing assembly and move the torso assembly relative to the mobile base so that the captured bin fits as closely as possible within the cross-sectional envelope of the mobile base.

2. The system of claim 1, further comprising a sensor operatively coupled to the controller and configured to sense one or more factors regarding an environment in which the mobile base is navigated.

3. The system of claim 2, wherein the sensor comprises a sonar sensor.

4. The system of claim 3, wherein the sonar sensor is coupled to the mobile base.

5. The system of claim 2, wherein the sensor comprises a laser range finder.

6. The system of claim 5, wherein the laser rangefinder is configured to scan a forward field of view that is greater than about 90 degrees.

7. The system of claim 6, wherein the laser rangefinder is configured to scan a forward field of view that is about 180 degrees.

8. The system of claim 5, wherein the sonar sensor is coupled to the mobile base.

9. The system of claim 2, wherein the sensor comprises an image capture device.

10. The system of claim 9, wherein the image capture device comprises a 3-D camera.

11. The system of claim 9, wherein the image capture device is coupled to the head assembly.

12. The system of claim 9, wherein the image capture device is coupled to the mobile base.

13. The system of claim 9, wherein the image capture device is coupled to the releasable bin-capturing assembly.

14. The system of claim 9, wherein the image capture device is coupled to the torso assembly.

15. The system of claim 1, wherein the mobile base comprises a differential drive configuration having two driven wheels.

16. The system of claim 15, wherein each of the driven wheels is operatively coupled to an encoder that is operatively coupled to the controller and configured to provide the controller with input information regarding a driven wheel position.

17. The system of claim 16, wherein the controller is configured to operate the driven wheels to navigate the mobile base based at least in part upon the input information from the driven wheel encoders.

18. The system of claim 2, wherein the controller is configured to operate the mobile base based at least in part upon signals from the sensor.

19. The system of claim 1, wherein the torso assembly is movably coupled to the mobile base such that the torso may be controllably elevated and lowered along an axis substantially perpendicular to the plane of the floor.

20. The system of claim 1, wherein torso assembly is movably coupled to the mobile base such that the torso may be controllably moved along an axis substantially parallel to the plane of the floor.

21. The system of claim 1, wherein the head assembly comprises an image capture device.

22. The system of claim 21, wherein the image capture device comprises a 3-D camera.

23. The system of claim 21, wherein the image capture device is movably coupled to the head assembly such that it may be controllably panned or tilted relative to the head assembly.

24. The system of claim 1, wherein the bin-capturing assembly comprises a under-ledge capturing surface configured to be interfaced with a ledge geometry feature of the bin.

25. The system of claim 24, wherein the capturing surface comprises a rail.

26. The system of claim 24 wherein the rail and ledge geometry feature of the bin are substantially straight.

27. The system of claim 1, further comprising a wireless transceiver configured to enable a teleoperating operator to remotely connect with the controller from a remote workstation, and to operate at least the mobile base.

28. The system of claim 27, wherein the controller is configured to navigate, observe the environment, and engage with one or more bins based at least in part upon teleoperation signals through the wireless transceiver from the teleoperating operator.

29. The system of claim 9, wherein the controller is configured to use the image capture device to automatically recognize the bin.

30. The system of claim 29, wherein one or more tags are coupled to the bin, the tags being configured to be recognizable and readable by the controller using the image capture device.

31. The system of claim 30, wherein at least one of the one of more tags is configured to assist the controller in determining the identification of the bin.

32. The system of claim 30, wherein at least one of the one or more tags is configured to assist the controller in determining the geometric pose of the bin.

33. The system of claim 30, wherein the one or more tags are selected from the group consisting of a QR code, an AR tag, a 2-D barcode, and a 3-D barcode.

34. The system of claim 33, wherein the one or more tags are passive.

35. The system of claim 33, wherein the one or more tags are actively-powered.

36. The system of claim 9, wherein the controller is configured to use the image capture device to automatically recognize one or more tags associated with a location in the nearby environment.

37. The system of claim 36, wherein at least one of the one of more tags is configured to assist the controller in determining the identification of the location.

38. The system of claim 36, wherein at least one of the one or more tags is configured to assist the controller in determining the geometric pose of the location.

39. The system of claim 36, wherein the one or more tags are selected from the group consisting of a QR code, an AR tag, a 2-D barcode, and a 3-D barcode.

40. The system of claim 39, wherein the one or more tags are passive.

41. The system of claim 39, wherein the one or more tags are actively-powered.

42. The system of claim 9, wherein the controller is configured to use the image capture device to automatically recognize one or more tags associated with an object in the nearby environment.

43. The system of claim 42, wherein at least one of the one of more tags is configured to assist the controller in determining the identification of the object.

44. The system of claim 42, wherein at least one of the one or more tags is configured to assist the controller in determining the geometric pose of the object.

45. The system of claim 42, wherein the one or more tags are selected from the group consisting of a QR code, an AR tag, a 2-D barcode, and a 3-D barcode.

46. The system of claim 45, wherein the one or more tags are passive.

47. The system of claim 45, wherein the one or more tags are actively-powered.

48. A method for managing bins of physical objects in a human environment, comprising:
a. providing a personal robotic system comprising an electromechanical mobile base defining a cross-sectional envelope when viewed in a plane substantially parallel to a plane of a floor upon which the mobile base is operated; a torso assembly movably coupled to the mobile base; a head assembly movably coupled to the torso; a releasable bin-capturing assembly movably coupled to the torso; and a controller operatively coupled to the mobile base, torso assembly, head assembly, and bin-capturing assembly; and
b. operating the personal robotic system to capture a bin with the bin-capturing assembly and move the torso assembly relative to the mobile base so that the captured bin fits as closely as possible within the cross-sectional envelope of the mobile base.

49. The method of claim 48, further comprising providing a sensor operatively coupled to the controller and configured to sense one or more factors regarding an environment in which the mobile base is navigated.

50. The method of claim 49, wherein the sensor comprises a sonar sensor.

51. The method of claim 50, wherein the sonar sensor is coupled to the mobile base.

52. The method of claim 49, wherein the sensor comprises a laser range finder.

53. The method of claim 52, wherein the laser rangefinder is configured to scan a forward field of view that is greater than about 90 degrees.

54. The method of claim 53, wherein the laser rangefinder is configured to scan a forward field of view that is about 180 degrees.

55. The method of claim 52, wherein the sonar sensor is coupled to the mobile base.

56. The method of claim 49, wherein the sensor comprises an image capture device.

57. The method of claim 56, wherein the image capture device comprises a 3-D camera.

58. The method of claim 56, wherein the image capture device is coupled to the head assembly.

59. The method of claim 56, wherein the image capture device is coupled to the mobile base.

60. The method of claim 56, wherein the image capture device is coupled to the releasable bin-capturing assembly.

61. The method of claim 56, wherein the image capture device is coupled to the torso assembly.

62. The method of claim 48, wherein the mobile base comprises a differential drive configuration having two driven wheels.

63. The method of claim 62, wherein each of the driven wheels is operatively coupled to an encoder that is operatively coupled to the controller and configured to provide the controller with input information regarding a driven wheel position.

64. The method of claim 63, wherein the controller is configured to operate the driven wheels to navigate the mobile base based at least in part upon the input information from the driven wheel encoders.

65. The method of claim 49, wherein the controller is configured to operate the mobile base based at least in part upon signals from the sensor.

66. The method of claim 48, wherein the torso assembly is movably coupled to the mobile base such that the torso may be controllably elevated and lowered along an axis substantially perpendicular to the plane of the floor.

67. The method of claim 48, wherein torso assembly is movably coupled to the mobile base such that the torso may be controllably moved along an axis substantially parallel to the plane of the floor.

68. The method of claim 48, wherein the head assembly comprises an image capture device.

69. The method of claim 68, wherein the image capture device comprises a 3-D camera.

70. The method of claim 68, wherein the image capture device is movably coupled to the head assembly such that it may be controllably panned or tilted relative to the head assembly.

71. The method of claim 48, wherein the bin-capturing assembly comprises a under-ledge capturing surface configured to be interfaced with a ledge geometry feature of the bin.

72. The method of claim 71, wherein the capturing surface comprises a rail.

73. The method of claim 71 wherein the rail and ledge geometry feature of the bin are substantially straight.

74. The method of claim 48, further comprising providing a wireless transceiver configured to enable a teleoperating operator to remotely connect with the controller from a remote workstation, and to operate at least the mobile base.

75. The method of claim 74, wherein the controller is configured to navigate, observe the environment, and engage with one or more bins based at least in part upon teleoperation signals through the wireless transceiver from the teleoperating operator.

76. The method of claim 56, wherein the controller is configured to use the image capture device to automatically recognize the bin.

77. The method of claim 76, wherein one or more tags are coupled to the bin, the tags being configured to be recognizable and readable by the controller using the image capture device.

78. The method of claim 77, wherein at least one of the one of more tags is configured to assist the controller in determining the identification of the bin.

79. The method of claim 77, wherein at least one of the one or more tags is configured to assist the controller in determining the geometric pose of the bin.

80. The method of claim 77, wherein the one or more tags are selected from the group consisting of a QR code, an AR tag, a 2-D barcode, and a 3-D barcode.

81. The method of claim 80, wherein the one or more tags are passive.

82. The method of claim 80, wherein the one or more tags are actively-powered.

83. The method of claim 56, wherein the controller is configured to use the image capture device to automatically recognize one or more tags associated with a location in the nearby environment.

84. The method of claim 83, wherein at least one of the one of more tags is configured to assist the controller in determining the identification of the location.

85. The method of claim 83, wherein at least one of the one or more tags is configured to assist the controller in determining the geometric pose of the location.

86. The method of claim 83, wherein the one or more tags are selected from the group consisting of a QR code, an AR tag, a 2-D barcode, and a 3-D barcode.

87. The method of claim 86, wherein the one or more tags are passive.

88. The method of claim 86, wherein the one or more tags are actively-powered.

89. The method of claim 56, wherein the controller is configured to use the image capture device to automatically recognize one or more tags associated with an object in the nearby environment.

90. The method of claim 89, wherein at least one of the one of more tags is configured to assist the controller in determining the identification of the object.

91. The method of claim 89, wherein at least one of the one or more tags is configured to assist the controller in determining the geometric pose of the object.

92. The method of claim 89, wherein the one or more tags are selected from the group consisting of a QR code, an AR tag, a 2-D barcode, and a 3-D barcode.

93. The method of claim 92, wherein the one or more tags are passive.

94. The method of claim 92, wherein the one or more tags are actively-powered.
